(19) United States
(12) Patent Application Publication
(10) Pub. No.: US 2025/0361958 A1
(43) Pub. Date: Nov. 27, 2025

(54) Quick Connector Structure

(71) Applicant: Yung-Hsiang LI, Tainan (TW)

(72) Inventor: Yung-Hsiang LI, Tainan (TW)

(73) Assignee: Yung-Hsiang LI, Tainan (TW)

(21) Appl. No.: 18/673,336

(22) Filed: May 24, 2024

(51) Int. Cl. F16L 37/02; F16J 15/3268

(52) U.S. Cl. CPC F16L 37/02; F16J 15/3268

(57) ABSTRACT

The present invention provides a quick connector structure, which includes a female connector and a male connector. The female connector includes an insertion slot arranged therein, an annular slot arranged on the wall of the insertion slot, and a wall sealing ring arranged in the annular slot. The male connector includes a insertion portion arranged thereon. The insertion portion is inserted into the insertion slot, the wall sealing ring is sleeved on the insertion portion. The female connector includes a groove arranged on the inner end surface of the insertion slot thereof and an end washer arranged in the groove. The end surface of the male connector abuts against the end washer of the female connector. Through the double sealing of the end washer and the wall sealing ring provided in the female connector, the insertion sealing effect of the male connector and the female connector can be better.

### BACKGROUND OF THE PRESENT INVENTION

### Field of Invention

The invention relates to a quick connector structure that can improve the insertion sealing effect of a male connector and a female connector.

### Description of Related Arts

A conventional quick connector 1, as shown in FIG. 1, mainly has a female connector 10 and a male connector 11. The female connector 10 includes an insertion slot 100 provided therein, an annular slot 101 provided on the wall of the insertion slot 100, and a sealing ring 102 provided in the annular slot 101. The male connector 11 has an insertion portion 110. The insertion portion 110 is inserted into the insertion slot 100 of the female connector 10, and the sealing ring 102 is sleeved on the insertion portion 110 of the male connector 11, and the sealing ring 102 abuts against the insertion portion 110 of the male connector 11 to achieve sealing when the male connector 11 and the female connector 10 are connected. However, the conventional quick connector 1 is only sealed by the sealing ring 102 when the male connector 11 and the female connector 10 are connected. The sealing effect is limited, and air leakage will still occur at the end, which will affect the connection effect.

### SUMMARY OF THE PRESENT INVENTION

The main purpose of the present invention is to provide a quick connector structure that can achieve a better insertion sealing effect between the male connector and the female connector.

The quick connector structure of the present invention mainly includes a female connector and a male connector, wherein the female connector includes an insertion slot arranged therein, an annular slot arranged on the wall of the insertion slot, and a wall sealing ring arranged in the annular slot, wherein the male connector includes a insertion portion arranged thereon, wherein the insertion portion is inserted into the insertion slot of the female connector, the wall sealing ring is sleeved on the insertion portion of the male connector,

wherein the female connector includes a groove arranged on the inner end surface of the insertion slot thereof and an end washer arranged in the groove, wherein the end surface of the male connector abuts against the end washer of the female connector.

The advantage of the quick connector structure of the present invention is that it strengthens the sealing effect of the end of the male connector, resulting in a better sealing effect after the connection between the male and female connectors.

### BRIEF DESCRIPTION OF THE DRAWINGS

FIG. 1 illustrates a sectional view of a conventional quick connector.

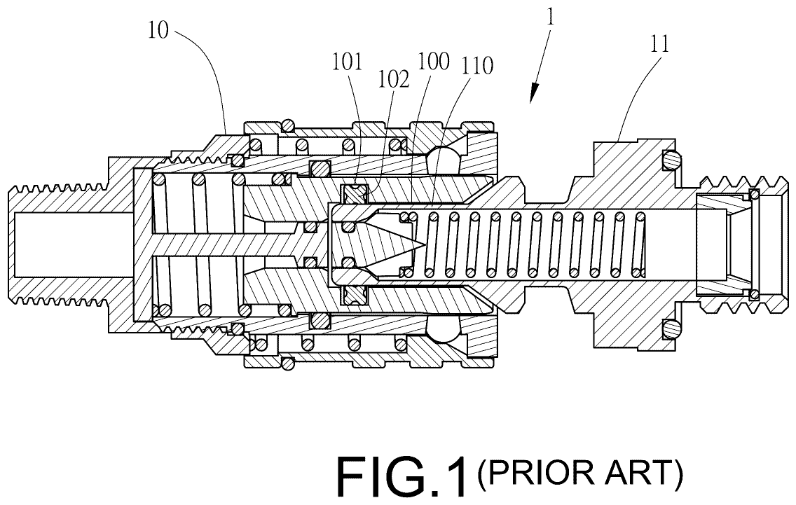

FIG. 2 illustrates an exploded view of an embodiment of the present invention.

FIG. 3 illustrates an assembled perspective sectional view of the embodiment of the present invention.

FIG. 4 illustrates an assembled sectional view of the embodiment of the present invention.

### DETAILED DESCRIPTION OF THE PREFERRED EMBODIMENT

Regarding the technical means adopted by the present invention to achieve the above-mentioned purposes and effects, the best and feasible embodiments are enumerated and shown in the drawings, and are described in detail as follows:

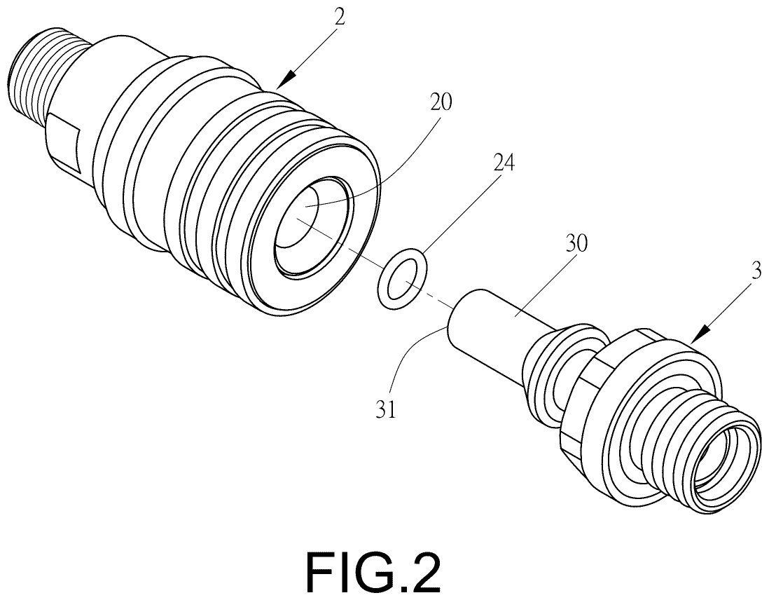

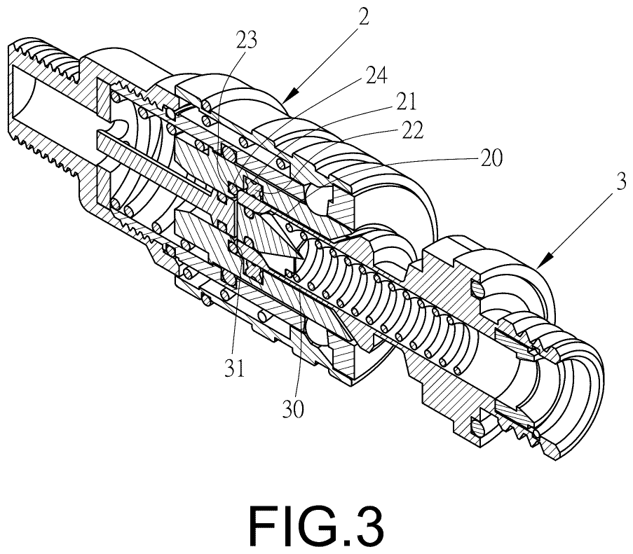

In the embodiment of the present invention, referring to FIGS. 2 and 3. A quick connector structure mainly includes a female connector 2 and a male connector 3, wherein the female connector 2 includes a insertion slot 20 arranged therein, an annular slot 21 arranged on the wall of the insertion slot 20, a wall sealing ring 22 arranged in the annular slot 21, a groove 23 arranged on the inner end surface of the insertion slot 20 of the female connector 2, and an end washer 24 arranged in the groove 23, wherein the male connector 3 includes a insertion portion 30 arranged thereon, wherein the insertion portion 30 is inserted into the insertion slot 20 of the female connector 2, the wall sealing ring 22 is sleeved on the insertion portion 30 of the male connector 3, and the end surface 31 of the male connector 3 abuts against the end washer 24 of the female connector 2, so that is the quick connector structure.

When assembling the embodiment of the present invention, referring to FIGS. 2 and 3. Set the end washer 24 into the insertion slot 20 of the female connector 2, and embed the end washer 24 into the groove 23 of the female connector 2, and then insert the insertion portion 30 of the male connector 3 into the insertion slot 20 of the female connector 2, so that the end surface 31 of the male connector 3 is closely attached to the end washer 24, and the wall sealing ring 22 is sleeved on the wall surface of the insertion portion 30 of the male connector 3, so that the assembly can be completed.

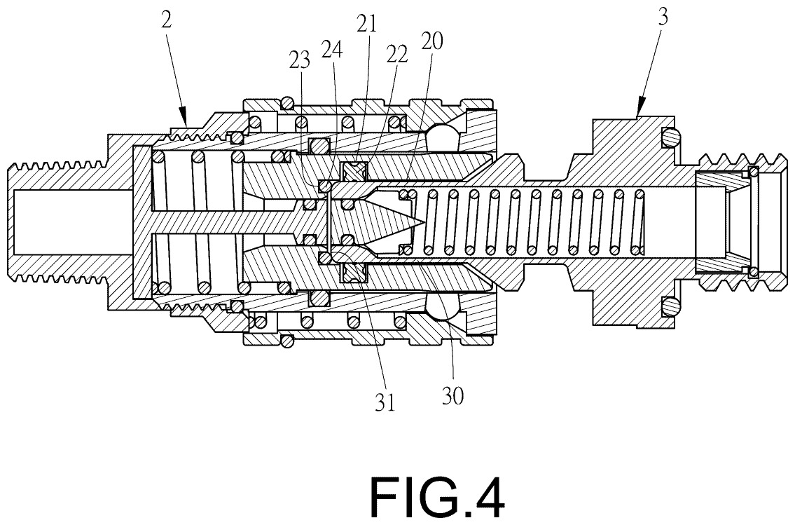

When using the present invention, referring to FIG. 4, and insert the insertion portion 30 of the male connector 3 into the insertion slot 20 of the female connector 2, so that the end surface 31 of the male connector 3 is closely attached the end washer 24, and the wall sealing ring 22 is sleeved on the wall surface of the insertion portion 30 of the male connector 3. In this way, through the double sealing of the end washer 24 and the wall sealing ring 22, the insertion portion 30 of the male connector 3 can be inserted into the insertion slot 20 of the female connector 2 with a better sealing effect, which can improve the use efficiency of the quick connector.

In summary, the present invention has indeed achieved the anticipated objectives and effects and is more ideal and practical than the prior art. However, the above-mentioned embodiments are only specific explanations for the preferred embodiments of the present invention, and this embodiment is not intended to limit the scope of the present invention. All equivalent variations and modifications completed under the technical means disclosed in the present invention should be included in the scope of patent protection of the present invention.

1. A quick connector structure, comprising a female connector and a male connector, wherein the female connector comprises an insertion slot arranged therein, an annular slot arranged on a wall of the insertion slot, and a wall sealing ring arranged in the annular slot, wherein the male connector comprises a insertion portion arranged thereon, wherein the insertion portion is inserted into the insertion slot of the female connector, the wall sealing ring is sleeved on the insertion portion of the male connector,
wherein the female connector comprises a groove arranged on an inner end surface of the insertion slot thereof and an end washer arranged in the groove in a movable manner, wherein an end surface of the male connector abuts against the end washer of the female connector.
